(19) United States
(12) Patent Application Publication
(10) Pub. No.: US 2023/0368281 A1
(43) Pub. Date: Nov. 16, 2023

(54) EQUIPMENT RENTAL SYSTEM AND METHOD

(71) Applicant: Oshkosh Corporation, Oshkosh, WI (US)

(72) Inventors: Korry D. Kobel, Oshkosh, WI (US); Fredric L. Yutzy, Oshkosh, WI (US)

(73) Assignee: Oshkosh Corporation, Oshkosh, WI (US)

(21) Appl. No.: 18/195,485

(22) Filed: May 10, 2023

Related U.S. Application Data
(60) Provisional application No. 63/340,685, filed on May 11, 2022.

(51) Int. Cl. G06Q 30/0645; G06Q 30/0283; G06Q 30/0601; B60R 25/01

(52) U.S. Cl. CPC G06Q 30/0645; G06Q 30/0284; G06Q 30/0643; B60R 25/01

(57) ABSTRACT

A method of facilitating the rental of a work machine includes receiving, from a user device, a rental search request including search criteria, the search criteria comprising a type of machine, a rental period, and a jobsite location, generating a user interface identifying one or more machines of the received type of machine that are available to rent during the rental period and are located within a predetermined or selected distance of the jobsite location, sending the user interface to a screen of the user device, receipt of the user interface causing the screen to display the user interface, and receiving, from the user device, a selection of a machine from the one or more machines indicating a request to rent the selected machine.

### CROSS-REFERENCE TO RELATED PATENT APPLICATIONS

This Application claims the benefit of and priority to U.S. Provisional Patent No. 63/340,685, filed May 11, 2022, which is hereby incorporated by reference herein in its entirety.

### BACKGROUND

Work equipment such as lifts and telehandlers often sit idle on jobsites during periods of time when they are not required. This results in wasted capacity that does not provide value to the equipment owner.

### SUMMARY OF THE INVENTION

One exemplary embodiment of the present disclosure relates to a method of facilitating the rental of a work machine. The method includes receiving, from a user device, a rental search request including search criteria, the search criteria including a type of machine, a rental period, and a jobsite location. The method further includes generating a user interface identifying one or more machines of the received type of machine that are available to rent during the rental period and are located within a predetermined or selected distance of the jobsite location and sending the user interface to a screen of the user device, receipt of the user interface causing the screen to display the user interface. The method includes receiving, from the user device, a selection of a machine from the one or more machines indicating a request to rent the selected machine.

In some aspects of the method, the user interface includes a list of the one or more machines organized in order from nearest to farthest from the jobsite location. Some aspects include filtering or sorting the list based on an additional attribute, wherein the additional criterion is one of an equipment manufacturer, a maximum operating parameter, a minimum operating parameter, a rental price, a fuel level, or a battery charge level. In some aspects, the user interface includes a map identifying the locations of the one or more machines. In some aspects the method includes receiving, from a connectivity module of the machine at the end of the rental period, a usage statistic including at least one of a change in battery charge during the rental period, a change in fuel level during the rental period, or an operating time of the machine during the rental period and calculating a final rental price based at least in part on the usage statistic. In some aspects, the method includes receiving, from an equipment owner device, availability data for one or more rentable machines. In some aspects, the method includes generating a rental agreement for the selected machine for the rental period, generating a second user interface containing the rental agreement, sending the second user interface to the screen of the user device. In some aspects, the method includes receiving, from the user device, an indication of consent to the rental agreement.

Another exemplary embodiment of the present disclosure relates to a method of picking up a rented work machine. The method includes receiving, from a user device, an indication that a user is at a pickup location for a rented work machine and sending, to the work machine in response to a user input via the user device, an access instruction, receipt of the access instruction causing one of unlocking a door of the machine, unlocking a lockbox positioned on the machine, or activating the machine.

In some aspects, the method includes determining whether the user has permission to pick up the work machine by confirming that a pickup window for the work machine has begun and has not ended, wherein the access instruction is sent to the machine only if the user's permission is confirmed. In some aspects, the method includes sending, to the work machine in response to a second user input via the user device, an identify instruction, receipt of the identify instruction causing the work machine to generate one or both of an audible signal or a visual signal. In some aspects of the method, the visual signal includes at least one of activating headlights of the work machine, activating interior cabin lights of the work machine, or activating a light of a beacon coupled to the work machine. In some aspects of the method, the audible signal includes at least one of activating a safety horn of the work machine or activating a sound generator or speaker of a beacon coupled to the work machine. In some aspects, the method includes determining whether the user has permission to pick up the work machine by confirming that a pickup window for the work machine has begun and has not ended, wherein the identify instruction is sent to the machine only if the user's permission is confirmed.

Another exemplary embodiment of the present disclosure relates to a non-transitory computer-readable storage medium. The medium has instructions stored thereon that, upon execution by a processor, cause the processor to receive, from one or more equipment owner devices, availability data for a plurality of rentable machines, receive, from a user device, a rental search request including search criteria, the search criteria including a type of machine, a rental period, and a jobsite location, generate a list of one or more of the plurality of rentable machines that matches the type of machine and is available for rent during the rental period, sort the list based on distance from each rentable machine to the jobsite location, and receive, from the user device, a selection of a rentable machine from the list, the selection indicating a request to rent the selected machine.

In some aspects, the instructions, upon execution by a processor, further cause the processor to generate a rental agreement for the selected machine for the rental period. In some aspects, the instructions, upon execution by a processor, further cause the processor to receive, from the user device, an indication of consent to the rental agreement, and in response to receiving the indication of consent, enable access to the selected machine during the rental period. In some aspects, enabling access to the selected machine during the rental period includes receiving, from the user device, an access request, determining that the access request was received during the rental period, and sending, in response to determining the access request was sent during the rental period, an access command to the selected machine. Receipt of the access command causes one of unlocking a door of the machine, unlocking a lockbox coupled to the machine, or activating the machine. In some aspects, the instructions, upon execution by a processor, further cause the processor to receive, from a connectivity module of the machine at the end of the rental period, a usage statistic including at least one of a change in battery charge during the rental period, a change in fuel level during the rental period, or an operating time of the machine during the rental period and calculate a final rental price based at least in part on the usage statistic.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a schematic representation of a work machine including a machine control module according to some embodiments.

FIG. 2 is a schematic representation of a local fleet connectivity system, according to some embodiments.

FIG. 3 is a schematic representation of a local fleet connectivity system with a central integration module, according to some embodiments.

FIG. 4 is a schematic representation of a work site and equipment staging area with a local fleet connectivity system deployed, according to some embodiments.

FIG. 5 is a picture representation of a work site with a local fleet connectivity system connecting two pieces of equipment, according to some embodiments.

FIG. 6 is a picture representation of a piece of equipment with a local fleet connectivity system providing connectivity to a remote user, according to some embodiments.

FIG. 7 is a schematic representation of a work site with a local fleet connectivity system deployed with connectivity to off-site systems, according to some embodiments.

FIG. 8 is a picture representation of an apparatus configured with a local fleet connectivity system, according to some embodiments.

FIG. 9 is a graphical user interface of the local fleet connectivity system of FIG. 2, according to some embodiments.

FIG. 10 is a picture representation of a work machine with machine specific output data connected to the local fleet connectivity system of FIG. 2, according to some embodiments

FIG. 11 is a picture representation of work machines configured for use in the local fleet connectivity system of FIG. 2, according to some embodiments.

FIG. 12 is a picture representation of a work machine provisioned with an integrated connectivity module and beacon, according to some embodiments.

FIG. 13 is a drawing representing a view of a user interface of an equipment identification system, according to some embodiments.

FIG. 14 is drawing of another view of the user interface of an equipment identification system of FIG. 13, according to some embodiments.

FIG. 15 is a flow diagram of a method for an equipment identification system, according to some embodiments.

FIG. 16 is a flow diagram of a method for a multiple machine identification system, according to some embodiments.

FIG. 17 is a flow diagram of a method of facilitating work machine rentals, according to some embodiments.

FIG. 18 is a flow diagram of a method of picking up a rented work machine, according to some embodiments.

FIG. 19 is a drawing representing a view of a user interface of an equipment rental application, according to some embodiments.

FIG. 20 is a drawing representing a view of a user interface of an equipment rental application, according to some embodiments.

FIG. 21 is a drawing representing a view of a user interface of an equipment rental application, according to some embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

On work sites encompassing a large area or involving many pieces of equipment, it is often difficult for equipment operators or service technicians to locate a particular piece of equipment to which they are assigned. It is therefore desirable to provide a means to quickly and effectively identify a particular machine or machines to a user thereby saving time, improving efficiency, and reducing costs.

Referring to the figures generally, various exemplary embodiments disclosed herein relate to systems and methods for an equipment identification system. For example, a system is configured to send instructions to work machine connectivity modules to illuminate a light or generate a sound, either with a beacon integrated into the connectivity module or with the lights and horn of the machine itself, responsive to a user interaction with an application (e.g. an “identify my machine” application). The equipment identification system assists users in locating a machine from among a group of machines on a work site through remote activation of visible and audible indicators on the machine (e.g., users enter commands on the “identify my machine” application to activate a beacon on a particular machine to distinguish it from a group of physically similar machines on a work site). Additionally, a work machine's lights and horn may be activated by the equipment identification system. In a further example, a beacon may be provided as a component of the equipment identification system. In another example, the equipment identification system may generate a user interface with a dynamic filter of a map to illustrate a total machine population. The user interface may also enable a remote user to apply such a filter to a specific jobsite network much the same as can be done locally via the mobile app. (in the instance where a remote user can apply the desired user configurable rules to assist a local user w/o the need of mobile app use). The equipment identification system may interoperate with a local fleet connectivity system that employs, for example, Bluetooth Low Energy (BLE) Machine to Machine (M2M) communication protocols to expand communication at a work site/jobsite between connected machines.

The figures also refer generally to the various exemplary embodiments disclosed herein relate to systems, apparatuses, and methods for a local fleet connectivity system. In some embodiments, the local fleet connectivity system can include work machines, interface modules, work site equipment, communications devices, communications networks, user interface devices, devices hosting self-forming network software, equipment users, equipment maintainers, and equipment suppliers. The information provided to the local fleet connectivity system can be communicated to a machine operator via a user interface. In some embodiments, the user interface includes a real time map, showing a current machine location, a machine status. In some embodiments, the user interface includes a color-coded warning indicator, an audible alarm, or another indicator structured to communicate to the machine operator that the work machine is in a location or state that requires the attention of the operator.

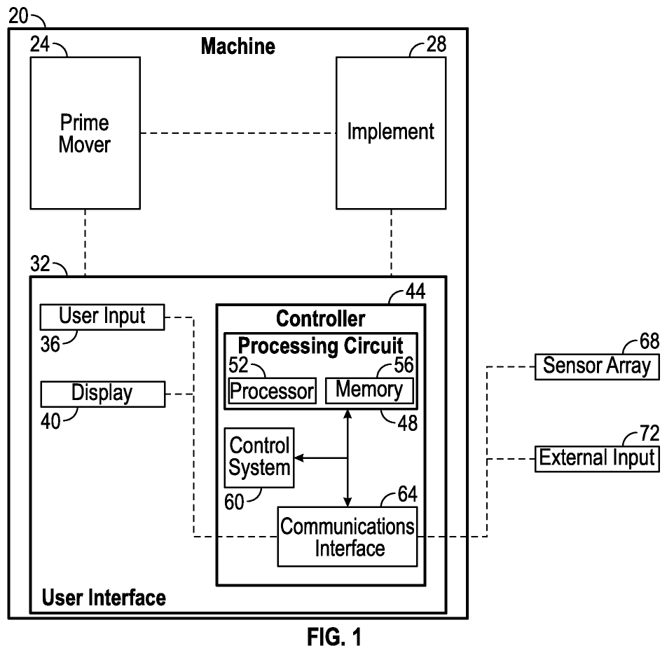

As shown in FIG. 1, a work machine 20 (e.g., a telehandler, a boom lift, a scissor lift, etc.) includes a prime mover 24 (e.g., a spark ignition engine, a compression ignition engine, an electric motor, a generator set, a hybrid system, etc.) structured to supply power to the work machine 20, and an implement 28 driven by prime mover 24. In some embodiments, the implement 28 is a lift boom, a scissor lift, a telehandler arm, etc.

A user interface 32 is arranged in communication with the prime mover 24 and the implement 28 to control operations of the work machine 20 and includes a user input 36 that allows a machine operator to interact with the user interface 32, a display 40 for communicating to the machine operator (e.g., a display screen, a lamp or light, an audio device, a dial, or another display or output device), and a control module 44.

As the components of FIG. 1 are shown to be embodied in the work machine 20, the controller 44 may be structured as one or more electronic control units (ECU). The controller 44 may be separate from or included with at least one of an implement control unit, an exhaust after-treatment control unit, a powertrain control module, an engine control module, etc. In some embodiments, the control module 44 includes a processing circuit 48 having a processor 52 and a memory device 56, a control system 60, and a communications interface 64. Generally, the control module 44 is structured to receive inputs and generate outputs for or from a sensor array 68 and external inputs or outputs 72 (e.g., a load map, a machine-to-machine communication, a fleet management system, a user interface, a network, etc.) via the communications interface 64.

The control system 60 generates a range of inputs, outputs, and user interfaces. The inputs, outputs, and user interfaces may be related to a jobsite, a status of a piece of equipment, environmental conditions, equipment telematics, an equipment location, task instructions, sensor data, equipment consumables data (e.g. a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, work machine twinning displays, commands, and data, etc.

The sensor array 68 can include physical and virtual sensors for determining work machine states, work machine conditions, work machine locations, loads, and location devices. In some embodiments, the sensor array includes a GPS device, a LIDAR location device, inertial navigation, or other sensors structured to determine a position of the equipment 20 relative to locations, maps, other equipment, objects, or other reference points.

In one configuration, the control system 60 is embodied as machine or computer-readable media that is executable by a processor, such as processor 52. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the control system 60 is embodied as hardware units, such as electronic control units. As such, the control system 60 may be embodied as one or more circuitry components including, but not limited to, processing circuitry, network interfaces, peripheral devices, input devices, output devices, sensors, etc. In some embodiments, the control system 60 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the control system 60 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The control system 60 may also include programmable hardware devices such as field programmable gate arrays, programmable array logic, programmable logic devices or the like. The control system 60 may include one or more memory devices for storing instructions that are executable by the processor(s) of the control system 60. The one or more memory devices and processor(s) may have the same definition as provided below with respect to the memory device 56 and processor 52. In some hardware unit configurations, the control system 60 may be geographically dispersed throughout separate locations in the machine. Alternatively, and as shown, the control system 60 may be embodied in or within a single unit/housing, which is shown as the controller 44.

In the example shown, the control module 44 includes the processing circuit 48 having the processor 52 and the memory device 56. The processing circuit 48 may be structured or configured to execute or implement the instructions, commands, and/or control processes described herein with respect to control system 60. The depicted configuration represents the control system 60 as machine or computer-readable media. However, as mentioned above, this illustration is not meant to be limiting as the present disclosure contemplates other embodiments where the control system 60, or at least one circuit of the control system 60, is configured as a hardware unit. All such combinations and variations are intended to fall within the scope of the present disclosure.

The hardware and data processing components used to implement the various processes, operations, illustrative logics, logical blocks, modules and circuits described in connection with the embodiments disclosed herein (e.g., the processor 52) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., control system 60 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device 56 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device 56 may be communicably connected to the processor 52 to provide computer code or instructions to the processor 52 for executing at least some of the processes described herein. Moreover, the memory device 56 may be or include tangible, non-transient volatile memory or non-volatile memory. Accordingly, the memory device 56 may include database components, object code components, script components, or any other type of information structure for supporting the various activities and information structures described herein.

In an exemplary embodiment, the memory device 56 stores instructions for execution by the processor 52 for a process to automatically generate a work site equipment grouping. The process to automatically generate a work site equipment grouping automatically associates machines 20 connected on a near network to one or more other machines 20. In some embodiments, the automatic associations are based on rule stored on a work machine or on another network node. In some embodiments, the association rules are based on one or more of a work site designation, a location of a machine, or a code (e.g. a customer key, a manufacturer key, or a maintainer key).

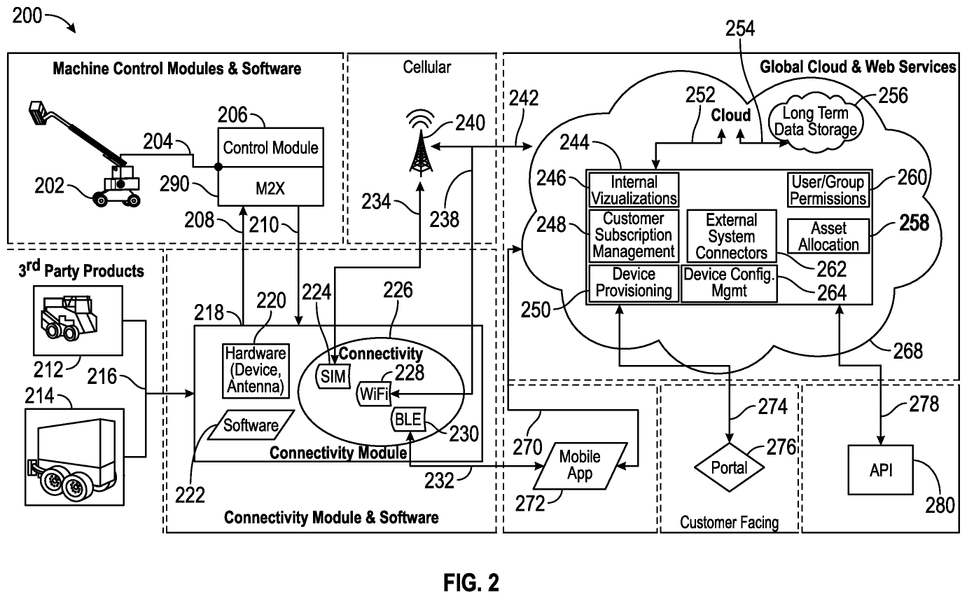

As shown in FIG. 2, the system for equipment identification system 200 is supported by a network of nodes. The network of nodes may include one or more work machines 202, each with a control module 206, one or more connectivity modules 218, and one or more network devices hosting, for example, user devices 272 including user interfaces, network portals 276, application interfaces/application programming interfaces 280, data storage systems 256, cloud and web services, and product development tool and application hubs 244.

The work machine 202 is communicably connected to a control module 206. The connection 204 between the work machine 202 and the control module 206 may be wired or wireless thus providing the flexibility to integrate the control module with the work machine 202 or to temporarily attach the control module 206 to the work machine 202. The control module 206 may be configured or may be reconfigurable in both hardware and software to interface with a variety of work machines 202, 212, 214 via the connectivity module 218. The control module 206 may comprise an integral power source or may draw power from the work machine 202 or another external source of power. Control modules 206 may be installed on or connected, e.g., via a connection 216, to products (e.g., third party products 212, 214) not configured by the original product manufacturer with a control module 206.

The work machine 202 communicably connects to the equipment identification system 200 via a machine-to-X (M2X) module 290. The M2X module 290 is communicably connected to the control module 206. The M2X module 290 establishes one or more communications channels 208, 210 with a connectivity module 218. The connectivity module 218 provides a plurality of links between one or more work machines 202, 212, 214 and the equipment identification system 200. Applications providing functions for the equipment identification system 200 may be run by the M2X modules on one or more work machines 202. One or more user devices 272 may be configured to communicate (e.g., to exchange commands, codes (e.g., a customer key) and data) with the connectivity modules of one or more machines via a network connection, for example via a local wireless connectivity system or via a cellular network (e.g., via cell towers 240) to form a network of interconnections among machines, devices, or nodes. Connections between machines and user devices in the equipment identification system 200 may be provided by a wireless mesh network, for example.

The connectivity module 218 comprises hardware 220, further comprising antennas, switching circuits, filters, amplifiers, mixers, and other signal processing devices for a plurality of wavelengths, frequencies, etc., software hosted on a non-volatile memory component 222, and a communications manager 226. The communications manager 226 may comprise processing circuits with communications front ends 224, 228, and 230 for one or more signal formats and waveforms including, for example, Bluetooth, Bluetooth low energy, Wi-Fi, cellular, optical, and satellite communications. The connectivity module 218 may function as a gateway device connecting work machine 202 to other work machines 212, 214, remote computing systems 244, 272, 276, and 280, beacons, scheduling or other fleet management and coordination systems.

The equipment identification system 200 allows for the coordination of multiple machines 202, 212, 214 within the same work site, or a fleet wide control. For example, a work machine 202 may remotely report the results of a self-inspection to a user via a user device 272 including a user interface.

The equipment identification system 200 provides connectivity between work machines 202, 212, 214 and remotely hosted user devices 272 including user interfaces, network portals 276, application interfaces/application programming interfaces 280, data storage systems 256, cloud and web services 268, and product development tool and application hubs 244 that function as an Internet of Things (IoT) system for operation, control, and support of work machines 202, 212, 214 and users of work machines. Connections 232, 234, 238, 242, 252, 254, 270, 274, and 278 between nodes connected to the equipment identification system 200 may comprise, for example, cellular networks (e.g., via cell towers 240), or other existing or new means of digital connectivity.

Product development tool and application hubs 244 may comprise tools and applications for internal visualizations 246, customer subscription management 248, device provisioning 250, external systems connectors 262, device configuration management 264, user/group permissions 260, asset allocation 258, fleet management, compliance, etc.

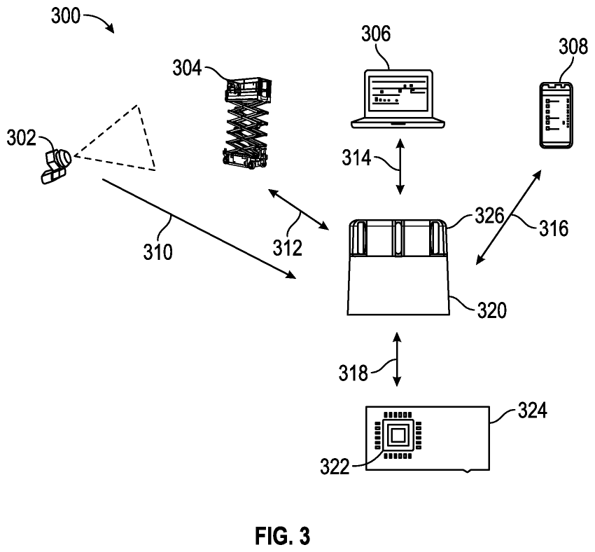

FIG. 3 shows an equipment identification system 300 according to an exemplary embodiment. As shown in FIG. 3, the connectivity module 320 functions as a communications interface between a control system 322 of the work machine 324 and other elements connected to the equipment identification system 200. The connectivity module 320 may be part of the work machine 324 or may be physically coupled to the work machine 324. The connectivity module 320 may exchange commands and data 318 with the control system 322 of the work machine 324, sensor data 310 with auxiliary sensors 302, machine data 312 with another machine 304, commands and data 314 with a node or portal 306, and commands and data 316 with a user device 308 running an application for the equipment identification system 300. The connectivity module 320 may exchange commands, codes (e.g., a customer key) and data between work machines 304, 324, user devices 308, and/or nodes 306 to form a network of interconnections among machines, devices, or nodes.

For example, in response to a user selection on an application hosted on the user device 308, one or more machines can be located and/or identified by one or both of a visual or audible signal from the selected machine or from the connectivity module coupled to the machine. For example, the connectivity module 320 may also include and/or function as a beacon 326 that may include one or both of a light or sound generator and may be configured to identify a machine by generating one or both of a visual or audible signal (e.g., alerts, indications, etc.). The connectivity module 320 may, for example, include a beacon 326 that includes a light (e.g., an RGB LED light) which is lit when a user presses a button on an application (e.g., an identify-my-machine application on a user device 308). Additionally or alternatively, the connectivity module 320 may be communicatively coupled to one or more lights (e.g., headlights, cabin lights, etc.) of the work machine 324 (e.g., via the control system 322) and can instruct the lights to generate the visible signals in response to the selection of a button on the user device 308. The beacon 326 may additionally or alternatively include a speaker to provide the audible signals. Additionally or alternatively, the connectivity module 320 may be communicatively coupled to a horn of the work machine 324 (e.g., via the control system 322) and can instruct the horn to sound to generate the audible signal in response to the selection of a button on the user device 308. The visual and audible signals can be used in conjunction or independently of one another. The beacon 326 may emit any or all combinations of frequency, color, patterns etc. of light and may emit any sound or message (e.g., recorded or computer-generated speech). The connectivity module 320 may be a self-contained unit. For example, the connectivity module 320 may be installed on or connected to machines not configured by the original product manufacturer with a connectivity module 320 and may be configured to communicate with the control module of the machine.

The equipment identification system 300 may, for example dynamically filter a user interface map to illustrate a total machine population connected to the equipment identification system. In a further example, a remote user may apply a filter to a specific work site network, much the same as can be done locally, via a mobile application. This allows a remote user to apply the desired user configurable rules to assist a local user that does not have access to a user interface of the equipment identification system 300. In some embodiments, the beacon 326 on the connectivity module 320 may include a light that may be used to illustrate or illuminate various machine statuses (e.g., fuel level, battery level, maintenance status, ignition on/off, in operation, etc.). For example, the light on the beacon 326 may be green when the fuel level is high and red when the fuel level is low. An application on a user device 308 can be used as an interface for a user to select which status they want to be displayed on a fleet within the connected range (e.g., distance, selected area, etc.) of a user device. The user may selectively command the beacons of one or more machines within the selected range to indicate the status or condition of the associated machine. For example, a user may select an option that turns the light green on machines that are to be used and turns the light red on machines that are not to be used. In some examples, selections may be independent of or in conjunction with the filter criteria of a desired subset of a fleet. In some embodiments, the user device 308 may be configured to send a command to the connectivity module 320 of a selected machine to power up or power down the machine. In some embodiments, the user device 308 may be configured to send a command to the connectivity module 320 of a selected machine to enable or disable operation of the machine.

The equipment identification system 300 allows for the coordination of multiple machines 324, 304 within the same work site, or a fleet wide control. For example, if a first work machine 304 is required to accomplish a task collaboratively with a second work machine 324, a user interacting with a user device 308 may provide commands to the first work machine 304 and second work machine 324 to execute the task in collaboration.

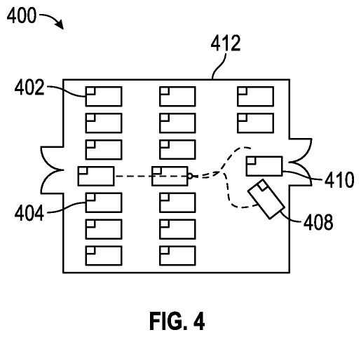

As shown in FIG. 4, the equipment identification system 400 may be deployed at a work site 412 to control a fleet of work machines 402, 404, 408, 410 via the connectivity module 406 to collaboratively perform tasks requiring more than one work machine 408, 410. For example, a user may wish to move the work machine 410 from its stored position on the left of the work site 412 out the door on the right of the work site. The connectivity module may communicate with both the work machine 408 and the work machine 410, causing the work machine 408 to move out of the way of the work machine 410, so that the work machine 410 can move past the work machine 408 and out the doorway.

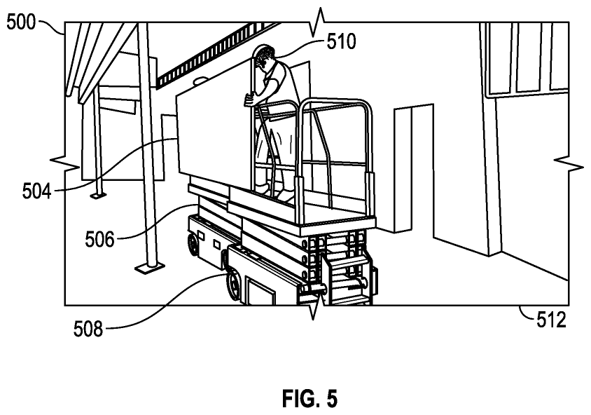

As shown in FIG. 5, a plurality of work machines 506, 508 connected to equipment identification system 500 may collaboratively perform tasks on a jobsite 512 requiring more than one work machine, for example emplacing a section of drywall 504 that is too large to be handled by a single work machine. A user device may communicate with both the work machine 506 and the work machine 508 and cause them to move at the same speed and in the same direction so that a user 510 on each machine 506, 508 can hold the drywall 504 while the machines 508, 506 are moving. Connectivity between the machines 508, 508 and with the equipment identification system 500 can prevent the machines 508, 506 from being separated so that the users 510 do not drop the drywall 504.

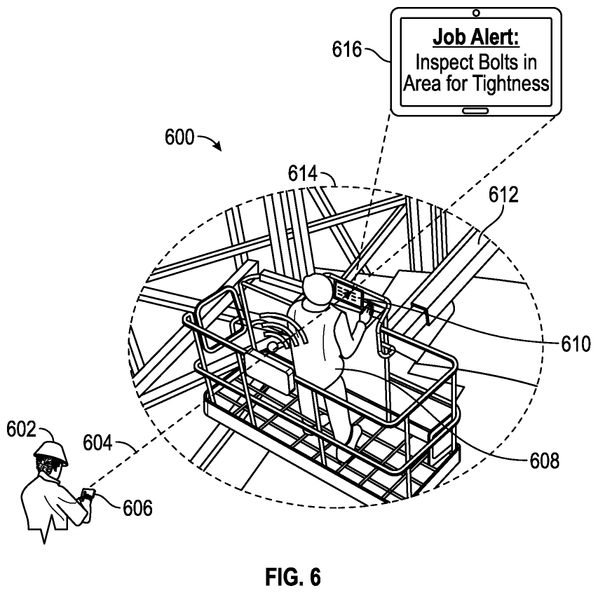

As shown in FIG. 6, a remote user 602 of an equipment identification system 600 can send messages and data 604 from a remote device 606 to an onsite user 608 on a jobsite 614. The messages and data 604 may be received by the control system 610 of a work machine 612 and displayed via a user interface on an onboard display 616. The remote user 608 may send work instructions to the onsite user 608, informing the onsite user 608 of talks to be performed using the work machine 612. For example, as shown in FIG. 6, the remote user 602 may send instructions to the onsite user 608 to use the work machine 612 to inspect bolt tightness in the area. The instructions may be displayed for the onsite user 608 on the onboard display 616. This allows the onsite user 608 to receive and view the instructions without the need to call the remote user 602 or write the instructions down. Because the work machine 612 is connected to the remote device 606 (e.g., via a connectivity module 218) the remote user 602 may receive the location of the work machine 612, as well as other work machines on the jobsite 614, and may use the location information to determine the instructions to send.

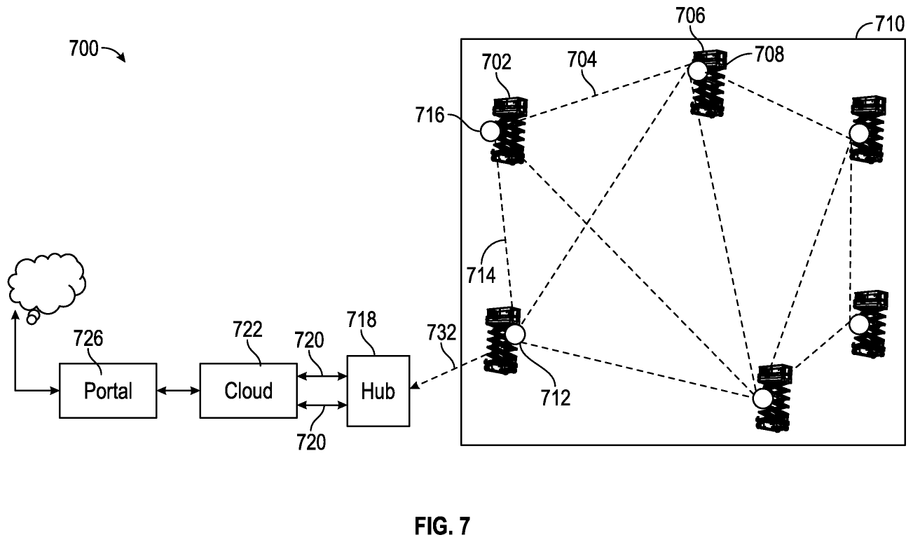

Referring to FIG. 7, a local fleet connectivity network system 700 includes a connectivity hub 718. In some embodiments, the connectivity hub includes a connectivity module. In some embodiments, the connectivity hub is configured to communicatively connect with one or more connectivity module equipped machines 702, 706 in proximity to the connectivity hub 718. In some embodiments, the connectivity hub is configured to broadcast a work site identification signal. In some embodiments, the connectivity hub is configured to connect work site machines 702, 706 connected to the local fleet network to an external internet feed 720. In some configurations, the connectivity hub is configured as a gateway to one or more communications systems or network systems to enable exchanges of data 720, 722 between nodes 708, 712, 716 on the work site 710 local fleet connectivity mesh network 704, 714, 732 and nodes 726 external to the work site.

In some embodiments, connectivity hub has a connectively module to (a) provides the functionalities described here in place of or in addition to a machine that has a connectivity module, (b) broadcasts a site identifier, or (c) connects to an external internet to flow through data to and from the jobsite that is provided across the mesh.

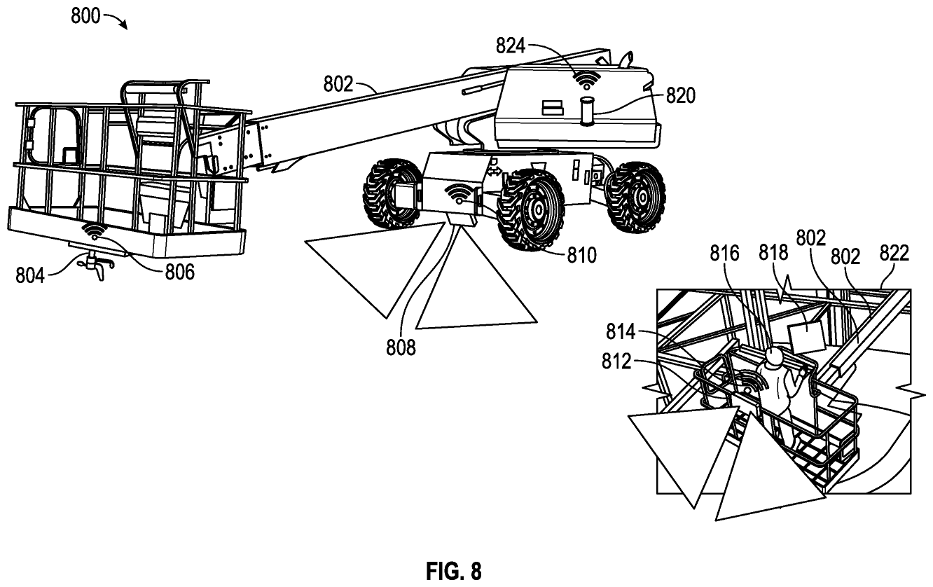

Referring to FIG. 8, a sensor network system 800 is shown. Sensors 804, 808, 812, 820 may be coupled to a work machine 802 on a jobsite 822. The sensors may be, for example, object detection sensors 808 812, environmental sensors 804 (e.g., wind speed, temperature sensors), and tagged consumable sensors 820. The sensors 804, 808, 812, 820 may be connected to and may send data to an equipment identification system via wireless connections 806, 810, 814, 824. The sensor data may be displayed or may be used to generate messages for display on an onboard display 818 for a user 816 of the work machine 802. The onboard display 818 may receive the sensor data via a direct wired or wireless connection to the sensors. Alternatively, the sensors may communicate with the onboard display through the equipment identification system (e.g., via a connectivity module 218). Sensor data from various work machines may be combined to map the jobsite 822 and to determine if environmental conditions are safe for using the work machines. Sensor data from the tagged consumable sensors 820 may be used to determine, for example, when tagged consumables must be replaced.

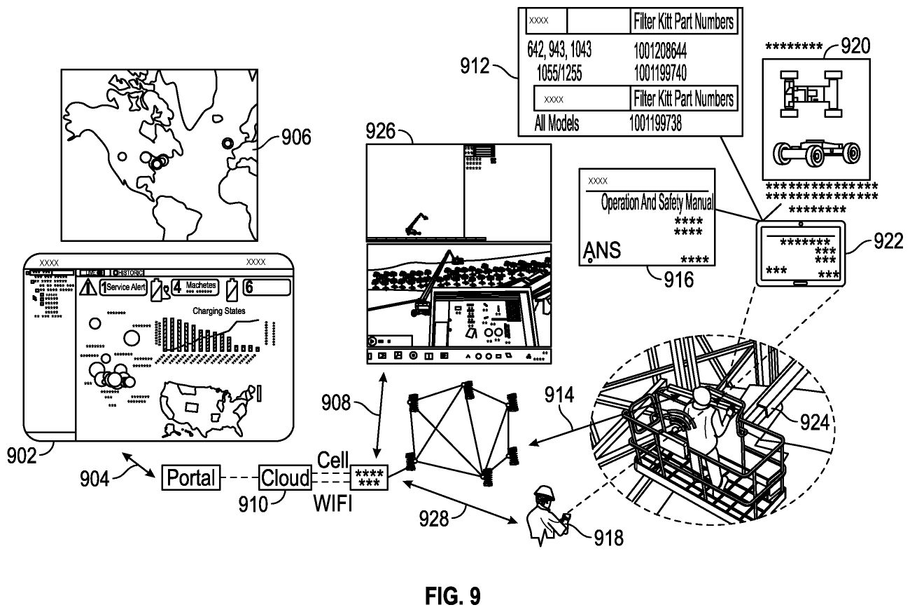

As shown in FIG. 9, various user interfaces are available to be displayed on a remote user device 918 and an onboard display 922 of a work machine 924. A connectivity hub 910 may send and receive data 928, 908, 904 914 including the user interfaces 902, 906, 912, 916, 926, 920. The user interface 906 is a heatmap of locations of a plurality of work machines. The user interface 902 is a machine status display that shows the battery level, location, and alerts relating to a plurality of work machines. User interface 926 shows a digital twin of a work machine that updates based on sensor data of an associated work machine. User interface 912 is a list of part numbers for the work machine 924. User interface 916 is an operation and safety manual for the work machine 924. User interface 920 is a detailed schematic of the work machine 924.

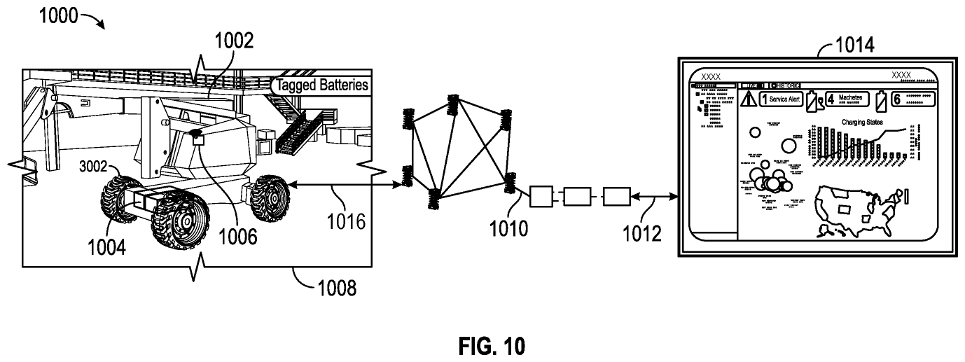

As shown in FIG. 10, a tagged consumable tracking system 1000 is shown. A work machine 1002 on a jobsite 1008 includes tagged consumables 1004 (e.g., batteries connected to battery charger 1006). The machine 1002 sends and receives data 1016 to and from the connectivity hub 1010. The connectivity hub 1010 sends and receives data 1012 to and from a user interface 1014. Data regarding the tagged consumables 1004 may be communicated to the user interface 1014 via the connectivity hub 1010. For example, battery charge state and battery health may be sent to the user interface 1014. When the battery health falls below a predetermined state, for example, when the battery is only able to hold half of its original charge, the connectivity hub 1010 may send an alert to the user interface 1014 indicating that the battery should be replaced.

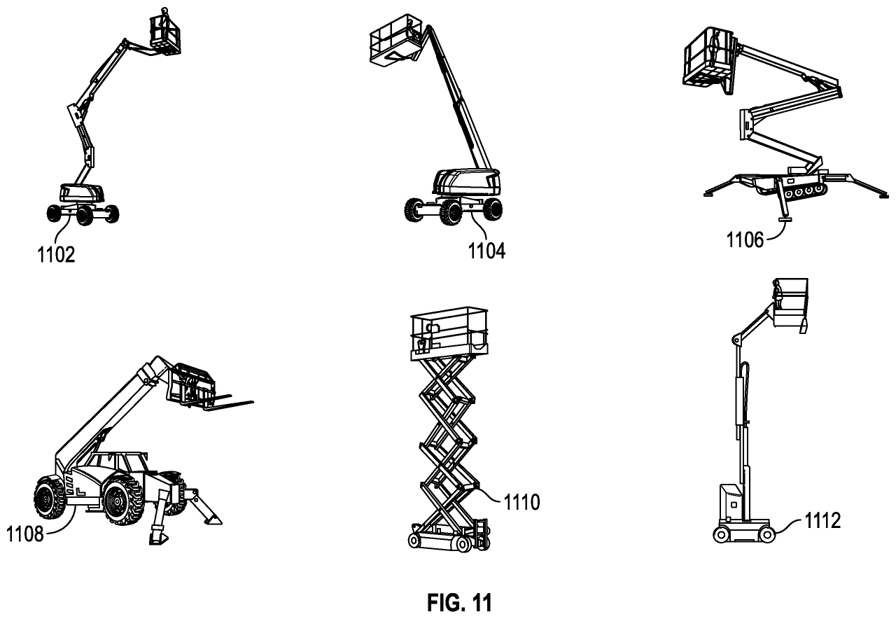

FIG. 11 shows various embodiments of a work machines 20 (e.g., lift devices including articulating boom lift 1102, telescoping boom lift 1104, compact crawler boom list 1106, telehandler 1108, scissor lift 1110, toucan mast boom lift 1112). As an example, telescoping boom lift 1104 includes a chassis (e.g., a lift base), which supports a rotatable structure (e.g., a turntable, etc.) and a boom assembly (e.g., boom). According to an exemplary embodiment, the turntable is rotatable relative to the lift base. According to an exemplary embodiment, the turntable includes a counterweight positioned at a rear of the turntable. In other embodiments, the counterweight is otherwise positioned and/or at least a portion of the weight thereof is otherwise distributed throughout the work machines 20 (e.g., on the lift base, on a portion of the boom, etc.). As shown in FIG. 11, a first end (e.g., front end) of the lift base is supported by a first plurality of tractive elements (e.g., wheels, etc.), and an opposing second end (e.g., rear end) of the lift base is supported by a second plurality of tractive elements (e.g., wheels). The front tractive elements and the rear tractive elements include wheels of telescoping boom lift 1104; however, in other embodiments the tractive elements include a track element.

As shown in FIG. 11, the boom of telescoping boom lift 1104 includes a first boom section (e.g., lower boom, etc.) and a second boom section (e.g., upper boom, etc.). In other embodiments, the boom includes a different number and/or arrangement of boom sections (e.g., one, three, etc.). According to an exemplary embodiment (e.g., articulating boom lift 1102), the boom is an articulating boom assembly. In one embodiment, the upper boom is shorter in length than lower boom. In other embodiments, the upper boom is longer in length than the lower boom. According to another exemplary embodiment, the boom is a telescopic, articulating boom assembly. By way of example, the upper boom and/or the lower boom may include a plurality of telescoping boom sections that are configured to extend and retract along a longitudinal centerline thereof to selectively increase and decrease a length of the boom.

As shown in FIG. 11, the lower boom of telescoping boom lift 1104 has a first end (e.g., base end, etc.) and an opposing second end (e.g., intermediate end). According to an exemplary embodiment, the base end of the lower boom is pivotally coupled (e.g., pinned, etc.) to the turntable at a joint (e.g., lower boom pivot, etc.). The boom includes a first actuator (e.g., pneumatic cylinder, electric actuator, hydraulic cylinder, etc.), which has a first end coupled to the turntable and an opposing second end coupled to the lower boom. According to an exemplary embodiment, the first actuator is positioned to raise and lower the lower boom relative to the turntable about the lower boom pivot.

As shown in FIG. 11, the upper boom of telescoping boom lift 1104 has a first end (e.g., intermediate end, etc.), and an opposing second end (e.g., implement end, etc.). According to an exemplary embodiment, the intermediate end of the upper boom is pivotally coupled (e.g., pinned, etc.) to the intermediate end of the lower boom at a joint (e.g., upper boom pivot, etc.). As shown in FIG. 11, the boom of telescoping boom lift 1104 includes an implement (e.g., platform assembly) coupled to the implement end of the upper boom with an extension arm (e.g., jib arm, etc.). In some embodiments, the jib arm is configured to facilitate pivoting the platform assembly about a lateral axis (e.g., pivot the platform assembly up and down, etc.). In some embodiments, the jib arm is configured to facilitate pivoting the platform assembly about a vertical axis (e.g., pivot the platform assembly left and right, etc.). In some embodiments, the jib arm is configured to facilitate extending and retracting the platform assembly relative to the implement end of the upper boom. The boom includes a second actuator (e.g., pneumatic cylinder, electric actuator, hydraulic cylinder, etc.). According to an exemplary embodiment, the second actuator is positioned to actuate (e.g., lift, rotate, elevate, etc.) the upper boom and the platform assembly relative to the lower boom about the upper boom pivot.

According to an exemplary embodiment, the platform assembly is a structure that is particularly configured to support one or more workers. In some embodiments, the platform assembly includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly includes a control panel to control operation of the work machines 20 (e.g., the turntable, the boom, etc.) from the platform assembly. In other embodiments, the platform assembly includes or is replaced with an accessory and/or tool (e.g., forklift forks, etc.).

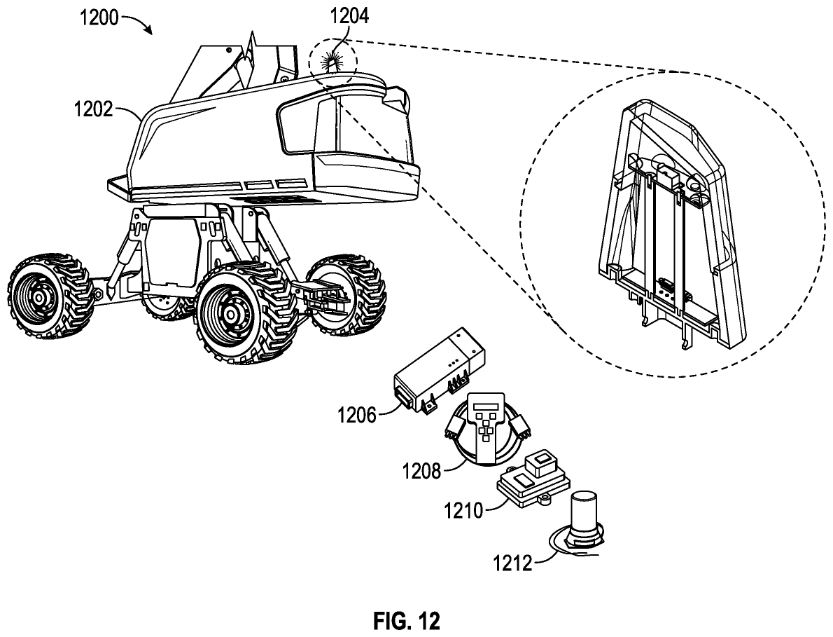

Referring to FIG. 12, a work machine 1202 is provisioned with an indicator 1204 (e.g., a connectivity module with integrated beacon light, control devices, and communications devices). The indicator 1204 may, for example, illuminate a light visible to a user in response to user activation of a “find my machine” or “identify my equipment” application hosted on a user device connected to the equipment identification system 200. The indicator 1204 may function like a conventional work machine warning beacon 1212.

In some embodiments, the connectivity module may be configured with a telematics control unit 1206, a multi-function light beacon 1212, one or more multi-channel communication modems 1210, one or more analytics devices 1208, one or more antennas, one or more power sources, one or more positioning systems, one or more local fleet connectivity processors, and one or more interface blocks, one or more machine connectivity provisions, and one or more memory devices. For example, the connectivity module with integrated beacon 1204 may be configured as an integrated connectivity device provisioned with all components required to connect a work machine 1202 that is not provisioned with networking equipment to an equipment identification system 200. The connectivity module with integrated beacon 1204 may include, for example, a telematics control unit specific componentry included (e.g., multi-color beacon, GPS/GNSS, communications modem, antenna, controller, memory device, interface blocks, housing, etc.) and be affixable to a work machine using temporary or permanent physical, electrical, or electronic connections. The connectivity module connected to the work machine may be configured to selectively enable, activate, disable, and deactivate components of the connectivity module and the work machine to which it is communicatively connected. For example, a connectivity module with integrated beacon 1204 connected to a work machine equipped with headlights may enable and activate the work machine headlights and disable the integral beacon in response to a “find me” command received by the connectivity module from the equipment identification system 200. The connectivity module with integrated beacon 1204 is configured, in some embodiments, to determine what components integral to the module and what components that are machine equipment are activated in response to a command such that only the components necessary to respond to the command are activated and no individual components are activated in conflict with the components activated to respond to the command.

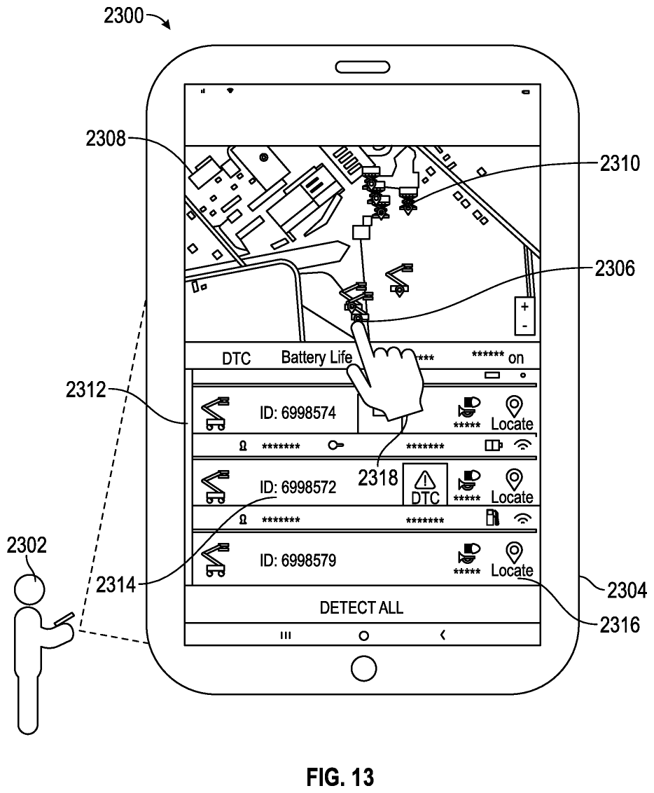

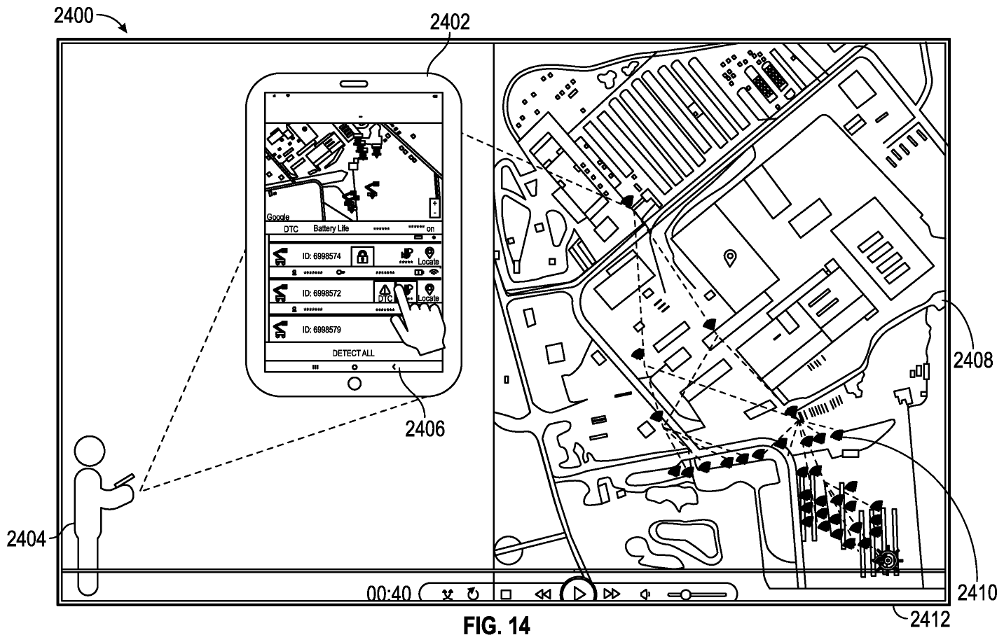

Referring to FIG. 13-14, a user 2302 may use the equipment identification system by interacting 2318 with an application hosted on a user device 2304 that generates a user interface 2308. The user device 2304 and various work machines 2306, 2310 are interconnected via the equipment identification system 200. The user 2302 selects a machine 2306 from a view 2308 of a group of machines 2310 connected to the equipment identification system 200 at a work site. The user interface 2308 may depict, for example, imagery of a work site with overlays of machine locations (e.g., a map) 2310 and information regarding machine specific information including status (e.g., location, fuel state, state of charge, etc.) 2312, 2314, 2316. The application may dynamically filter the map to illustrate the total machine population and locations and statuses of individual machines in the population. In some examples, a remote user may apply filters (e.g. proximity to a user, filters related to machine status including self-test, fuel level, state of charge, etc.) to a specific work site network much the same as can be done locally via an application on a mobile user device (e.g. in the instance where a remote user can apply the desired user configurable rules to assist a local user w/o the need of mobile application use). The user may select a machine or group of machines using an application and communicate with the machine or group of machines (directly or via a cloud) to have that machine provide an equipment identify indication (e.g., a colored light, a light pattern, a combination of light colors and patterns, activation of a horn).

Referring to FIG. 14, a user interface 2400 of a machine connectivity application is shown, according to an exemplary embodiment. The user interface 2400 may include a map 2408. The map may be an aerial view of a job site. The map 2408 may include machine indicators 2410 that show where machines are disposed on the map 2408. A light on a connectivity module can be used to identify a first machine 2412 of the plurality of machines within the job site and indicate various statuses of the first machine (e.g., fuel level, state of charge, fault status, ignition on/off, in operation, etc.). The application user interface 2406 on user device 2402 can be used by a user 2404 to select which status they want to be displayed on a fleet within user defined parameters (e.g., a connected range of the user device). Features of the “find me” application can be used independently of or in conjunction with the filter criteria of a desired subset of a fleet. The equipment identification system application can also provide user interfaces for other instructions or commands (e.g., allowing a machine to be powered up or shut down).

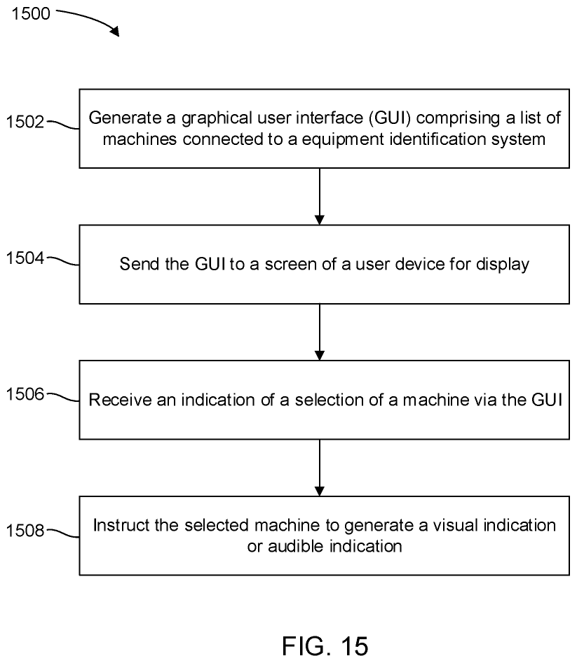

Referring to FIG. 15, a process 1500 (or method) for an equipment identification system (e.g., equipment identification systems 200, 300) is shown according to some embodiments. The method may be performed by one or more processing circuits comprising one or more memory devices coupled to one or more processors. The one or more memory devices may be configured to store instructions thereon that, when executed by the one or more processors, cause the one or more processors to perform the operations of the method. In some embodiments, the one or more processing circuits may be integrated into a remote computing system (e.g., cloud and web services 268). In other embodiments, the one or more processing circuits may be integrated into a user device (e.g., user device 272). One or more machines may connect to the user device via a local wireless connectivity system or via a cellular network (e.g., via cell towers 240), or other existing or new means of digital connectivity. Each machine may include a connectivity module for communicating with the equipment identification system (e.g., connectivity modules 218, 320). The one or more processing circuits may communicate across a wireless network by sending messages to the one or more machines and to one or more user devices each communicatively connected to the network. A user may interact with the machines via an application provided on the user device that displays a graphical user interface (GUI).

Following the activation of an equipment identification system and deployment of machines to a work site, machines connect to the system and are identified digitally within the system and applications provided through the system. Process 1500 begins at operation 1502 with the generation of a GUI including a list of one or more of the machines connected to the equipment identification system. In some embodiments, the list may include additional information regarding each machine (e.g., fuel level/SOC, DTC status, ignition on/off, in operation, etc.). In some embodiments, the list may include location information regarding each machine (e.g., work site name, latitude and longitude etc.). In some embodiments, the GUI may include a map with the location of each machine, as shown in FIG. 13. At operation 1504, the GUI is sent to a screen of a user device for display. The user device may be, for example, a smartphone, a tablet computer, a laptop computer, a desktop computer, or any device with a screen to display the GUI and that allows the user to interact with the application (e.g., to receive machine data, to send messages, instructions, or commands to the machines, etc.).

At operation 1506, an indication of a selection of a machine is received via the GUI. For example, a user may select a machine by clicking the machine name on the list of machines on the GUI with a mouse or touching it on a touchscreen device. At operation 1508, in response to receiving the selection of a machine from the list, an instruction is sent to the selected machine to generate a visual indication or audible indication. It should be understood that instructing the machine to generate an indication may include instructing a connectivity module coupled to the machine to generate the indication. The user may then identify the selected machine based on the visual or audible indication generated by the indicator. The indicator may be, for example, a beacon integrated into the connectivity module that includes a light which is lit when the instruction to generate the indication is received. Additionally or alternatively, the connectivity module can instruct the machine's lights (e.g., headlights, cabin lights, etc.) to act as the visible indicator. The beacon may additionally or alternatively include a speaker to provide the audible indication. Additionally or alternatively, the connectivity module can instruct the machine's horn to act as the audible indicator. The visual and audible indicators can be used in conjunction or independently of one another.

As an example of process 1500, a worksite may have ten machines (e.g., scissor lifts) that are the same model. The scissor lifts may connect to the equipment identification system. A user device (e.g., a tablet computer) may also connect to the equipment identification system. A GUI may be generated and displayed on the screen of the tablet computer. The GUI may include a list of the ten scissor lifts and their respective fuel levels. If, for example, one of the scissor lifts has a fuel level that is very low, the user may select that scissor lift. After the section is received, an instruction may be sent to the selected scissor lift to activate the beacon light of the connectivity module coupled to the selected scissor lift and generate a visual indication. The user may then locate the selected scissor lift based on the visual indication and refuel the selected scissor lift.

The user may apply one or more dynamic filters (e.g., machine feature or status criteria) to a map of machines at a work site through the application to illustrate one or more machine populations. In some implementations, the user may apply such a filter to a specific jobsite network much the same as can be done locally via a mobile application. The process 1500 may also include using a visual or audible indication on the machine to illustrate various statuses of the machine (fuel level/SOC, battery level, DTC status, ignition on/off, in operation, etc.). For example, an indication of a selection of a status or condition may be received via the GUI on the user device, and a message may be sent in response to the selection instructing the selected machines to indicate the selected status or condition using one or both of the visual or audible indication. The process 1500 may further include using the application as an interface for a user to select which status they want to be displayed on a fleet of machines within a connected range of the user's device or within a designated proximity to a user. The method may also include a user sending commands to a machine through the application (e.g., commanding an identified machine to be powered up or shut down, disabling, or enabling an identified machine, etc.). For example, an indication of a selection of on option to power up or power down a machine may be received via the GUI on the user device, and a message may be sent in response to the indication instructing the selected machine to power up or power down. As another example, an indication of a selection of on option to enable or disable a machine may be received via the GUI on the user device, and a message may be sent in response to the indication instructing the selected machine to enable or disable operation of the machine.

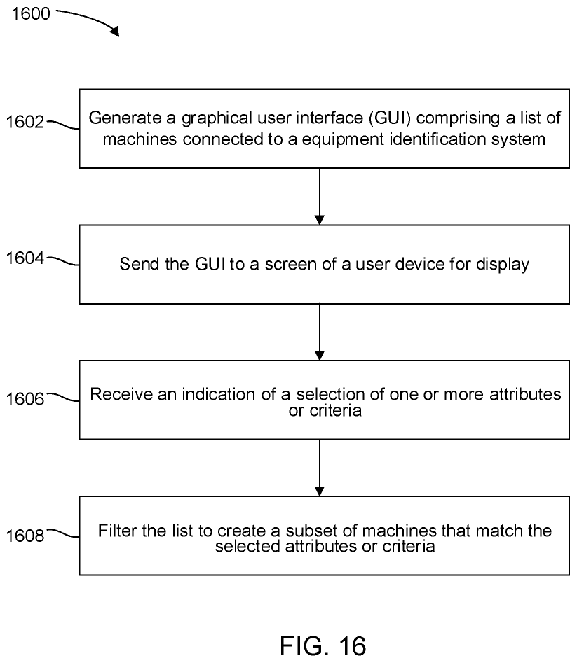

Referring to FIG. 16, a process 1600 (or method) for identifying multiple machines is shown according to some embodiments. The method may be performed by one or more processing circuits comprising one or more memory devices coupled to one or more processors. The one or more memory devices may be configured to store instructions thereon that, when executed by the one or more processors, cause the one or more processors to perform the operations of the method. In some embodiments, the one or more processing circuits may be integrated into a remote computing system (e.g., cloud and web services 268). In other embodiments, the one or more processing circuits may be integrated into a user device (e.g., user device 272). One or more machines may connect to the user device via a local wireless connectivity system or via a cellular network (e.g., via cell towers 240), or other existing or new means of digital connectivity. Each machine may include a connectivity module for communicating with the equipment identification system (e.g., connectivity modules 218, 320). The one or more processing circuits may communicate across a wireless network by sending messages to the one or more machines and to one or more user devices each communicatively connected to the network. A user may interact with the machines via an application provided on the user device that displays a graphical user interface (GUI).

Following activation of a local fleet connectivity system and deployment of machines to a work site, machines connect to the system and are identified digitally within the system and applications provided through the system. Process 1600 begins at operation 1602 with the generation of a GUI including a list of one or more of the machines connected to the equipment identification system. In some embodiments, the list may include additional information regarding each machine (e.g., fuel level/SOC, DTC status, ignition on/off, in operation, etc.). In some embodiments, the list may include location information regarding each machine (e.g., work site name, latitude and longitude etc.). In some embodiments, the GUI may include a map showing the location of each machine, as shown in FIG. 13. At operation 1604, the GUI is sent to the screen of a user device for display. The user device may be, for example, a smartphone, a tablet computer, a laptop computer, a desktop computer, or any device with a screen to display the GUI and that allows the user to interact with the application (e.g., to receive machine data, to send messages, instructions, or commands to the machines, etc.).

At operation 1606, an indication of a selection of one or more attributes or criteria is received from the user device. For example, a user may select attributes relating to the machines, such as a machine type, a battery status, a machine model number, a machine manufacturer, a machine location, a machine work site tag, a machine status, a repair status, a DTC status, a fuel status, a use status, or the number of other machines that must be used to access or move a machine. At operation 1608, the list is filtered to create a subset of the plurality of machines. The subset includes machines that match the selected attributes or criteria. For example, a user may filter the list by selecting an attribute of “has less than 25 percent fuel remaining.” The subset of machines that is created will then include only those machines with less than 25 percent fuel remaining. The subset may be further narrowed with additional criteria. When the GUI comprises a map showing a location of each machine, filtering the list may include temporarily removing machines from the map that do not match the selected attributes or criteria.

In some embodiments, a user may enter, via the GUI on the user device, a required number of machines. A subgroup containing the desired number of machines from the subset of machines may then be identified. A message may then be sent to the subgroup of machines instruction the machines to generate one or both of a visual indication or an audible indication. For example, if a new jobsite requires three scissor lifts, the user may filter the list of machines to create a subset that includes only scissor lifts. The user may then enter, via the GUI on the user device, the number of scissor lifts required at the new jobsite. A subgroup containing three scissor lifts may then be identified. A message may then be sent to the three scissor lifts causing the three scissor lifts to generate a visible or audible indication, such as illuminating a beacon of each lift. It should be understood that instructing the machine to generate an indication may include instructing a connectivity module coupled to the machine to generate the indication. In some embodiments, the subgroup of machines may be the machines in the subset of machines that are physically closest to the user device. In other embodiments, a user may select a desired location and the subgroup of the subgroup of machines may be the machines in the subset of machines that are physically closest to the selected location. In some embodiments the message sent to the machines instructs each machine to generate a visual or audible indicator that is different than the visual or audible indicator of the other machines. For example, each machine in the subgroup may display a different color light. In some embodiments, the GUI may update to indicate the visible or audible indicator associated with each machine. For example, the list may be updated to include each color being displayed by the respective machine. In some embodiments, the user may select one of the machines from the subgroup (e.g., by clicking the machine name on the list of machines on the GUI with a mouse or touching it on a touchscreen device) and a message may be sent to the selected machine, causing the selected machine to generate a second visual or audible indication. For example, a user may want to confirm that a machine corresponds to a certain machine from the list. The user may select the machine via the GUI on the user device and, for example, the light may flash on and off to indicate which machine corresponds to the selected machine from the list. The user may then identify the selected machine based on the visual or audible indication generated by the indicator.

In some embodiments, the subgroup of machines consists of the machines in the subset of machines can be moved to a selected location while moving a minimum number of machines from a plurality of machines. For example, if machines are stored in a warehouse, fewer machines will be required to be moved to allow a selected machine to move out of the warehouse door if the machine is closer to the door. A selected machine farther from the door may be blocked by several other machines that will have to be moved to allow the selected machine to move out the door. In some embodiments, the number of machines that must be moved to allow machines in the subset of machines to reach a selected location may be calculated and the subgroup may be determined based on the machines in the subset that require the fewest other machines to move.

A user may press a button on an application presented to the user on a user device (e.g., a smart phone). The application (e.g., an “identify my machine” application) generates a command to activate a visual indication (e.g., a beacon light) or an audible indication (e.g., a machine horn) or a combination of indications to indicate to a user the machines selected via the application. The user may apply one or more dynamic filters (e.g., machine feature or status criteria) to a map of machines at a work site through the application to illustrate one or more machine population. In some implementations, a remote user may apply such a filter to a specific jobsite network much the same as can be done locally via a mobile application. The method may also include using lights on machine connectivity modules to illustrate various statuses of machines (fuel level/SOC, DTC status, ignition on/off, in operation, etc.). The method may further include using the application as an interface for a user to select which status they want to be displayed on a fleet of machines within a connected range of the user's device or within a designated proximity to a user. The method may also include a user sending commands to machines through the application (e.g., commanding an identified machine to be powered up or shut down). In some embodiments, beacons on several machines can be used at one time to identify multiple machines both digitally in an application and on the machines. This would allow a person to pick a machine physically and tie it to the digital version of the machine, saving time searching for serial numbers and matching them. A user may also use an application to, for example, to identify a generic local group of machines nearest the user that fit a user defined criteria (e.g., which machine is easiest to pull out that is charged, no faults, and of a specific model). In some implementations, a user may simultaneously communicate with a plurality of machines (directly or via a cloud) that satisfy some selected criteria (e.g., a group of machines that are the same model) and have them separately identify themselves (e.g., with different color lights). A user can then, for example, select the “green machine”, and it might flash its lights to say, “this one?” and then the user may tap verify on the application to partner with that machine. Information from the selected machines could then filter back to the local fleet connectivity system based on the associations generated via the application.

### Equipment Rental

Work machines can often sit idle on a jobsite between periods of use. For example, a scissor lift may be required on the jobsite for a week and then may not be required on the jobsite for another month. The owner of the machine may transport the machine to be used on different jobsite when it is not needed on a first jobsite, but often it is more cost effective to leave the machine at the first jobsite until it is needed again. It may be advantageous to rent the machine to a third party when the machine would otherwise sit idle on a jobsite. For example, a contractor that needs a scissor lift for a short period of time could rent a scissor lift from the owner rather than purchasing one. Because jobsites may be distributed around a geographical area, the contractor may be able to pick up a nearby machine rather than travelling to a dedicated rental center. In some cases, it may be advantageous for larger contractors to collectively own a pool of shared machines. One contractor can use more machines while another uses less. Each machine may include a controller (e.g., controller 44, control module 206, etc.) as described above that may be configured to track usage of the machine.

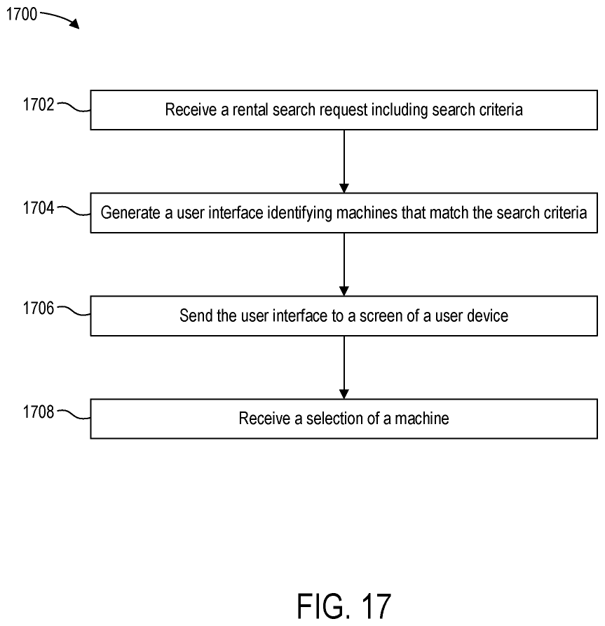

Referring to FIG. 17, a process 1700 (or method) of facilitating work machine rentals is shown, according to some embodiments. The method may be performed by one or more processing circuits comprising one or more memory devices (e.g., non-transitory computer-readable storage media) coupled to one or more processors. The one or more memory devices may be configured to store instructions thereon that, when executed by the one or more processors, cause the one or more processors to perform the operations of the method. In some embodiments, the one or more processing circuits may be integrated into a remote computing system (e.g., cloud and web services 268). In other embodiments, the one or more processing circuits may be integrated into a user device (e.g., user device 272). One or more machines may connect to the user device via a local wireless connectivity system or via a cellular network (e.g., via cell towers 240), or other existing or new means of digital connectivity. Each machine may include a connectivity module for communicating with the equipment identification system (e.g., connectivity modules 218, 320). The one or more processing circuits may communicate across a wireless network by sending messages to the one or more machines and to one or more user devices each communicatively connected to the network. A user may interact with the machines via an application provided on the user device that displays user interfaces on a screen. The user device may be, for example, a smartphone, a tablet computer, a laptop computer, a desktop computer, or any device with a screen to display the GUI and that allows the user to interact with the application.

At operation 1702 of the process 1700, a rental search request is received. For example, a user (e.g., a machine renter) may open an application for facilitating machine rentals on a user device and enter search criteria relating to the machine the user wants to rent (e.g., via a GUI). The user may enter the type of equipment needed and the time period that the equipment will be rented (e.g., the rental period). The user may enter the location where the equipment will be used (e.g., a jobsite location). In some embodiments, the application may detect the location of the user device, and the user may select an option to use the location of the user device. At operation 1704 of the process 1700, a user interface is generated that includes a list identifying machines that match the search criteria input by the user in the rental search request submitted in operation 1702. For example, machines that match the type selected by the user in operation 1702, that are available during the rental period, and that are located within a predetermined or selected (e.g., selected by the user via the user interface) distance of the jobsite location. At operation 1706, the user interface is sent to the user device. Receipt of the user interface may cause a screen of the user device to display the user interface.

Equipment matching the input search criteria can be identified from various jobsites and various fleet connectivity systems. Machine owners can enter the rental availability dates of each machine via an owner portal application on an equipment owner device. The rental availability dates can be stored (e.g., in the cloud 268) and accessed by the renter application. In some embodiments, the owner can enter the number of similar machines at each jobsite and the number of those machines needed on the jobsite on each date. The remaining number of machines can be rented out. For example, if a jobsite has twenty scissor lifts, the owner may indicate that fifteen scissor lifts are needed on the jobsite from May 1 through May 10. The application may list all twenty of the scissor lifts as available for rent until five have been rented. Then, the remaining fifteen may be removed from the list of available machines.

In some embodiments, machines owned by various owners can be identified. For example, the owner portal application can be made available to multiple equipment owners, who can each list their available equipment. In some embodiments, the list of machines matching the input search criteria may include additional information regarding each machine (e.g., fuel level/SOC, DTC status, availability dates, etc.). The list may include location information regarding each machine (e.g., work site name, latitude and longitude etc.). The identified machines may be listed or sorted in order of distance (e.g., nearest to farthest) from the location where the machine will be used, as input by the user. In some embodiments, the user interface may include a map showing the location of each machine, as shown in FIG. 13. The map may be centered around the location where the machine will be used, as input by the user, and may show all machines matching the search criteria within a certain radius of the input location. In some embodiments, the radius may be user-input.

After the machines matching the search criteria are identified, the user may input one or more additional attributes or criteria to further filter and/or sort the list of available machines. For example, a user may select attributes relating to the machines, such as a battery status, a machine manufacturer, a machine location, the age of the machine, a fuel or battery charge level, a maximum or minimum operating parameter (e.g., height, load capacity, speed, weight, etc.), a rental price (e.g., price per day, price per minute of use, delivery price, etc.) etc. As discussed above, the machines may communicate this data to the cloud 268 via the connectivity module 218. In some embodiments, some or all of this data may be entered by the owner via the owner portal application. The renter application may communicate with the cloud 268 to receive the machine data. The user may also select criteria relating to the rental terms. For example, the user may select a maximum daily rental fee, a preferred machine owner (if there are multiple owners with machines listed for rent in the application), whether delivery is available, hours of pickup and drop-off, etc. The machine owners may enter this information via the owner portal application. The list of available machines may be filtered based on the additional attributes or criteria input by the user.

At operation 1708, a selection of a machine is received from the user indicating a request to rent the selected machine. The user may also specify pickup and drop-off times or schedule a delivery. A rental agreement may then be generated for the user, and a second GUI containing the agreement may be generated, sent to the user device, and displayed on the screen of the user device. The rental agreement may include the terms of the rental, including the rental period, pickup and drop-off times, and the fee structure for the rental. The user may indicate consent to the agreement (e.g., by making selections and/or signing the agreement using the GUI) and submit payment information (e.g., a credit card number, a business name and address for receiving invoices, etc.). The indication of consent may then be received at the one or more processing circuits. In response to receiving the indication of consent, access to the machine may be enabled during the rental period. The user may use the user device to send an access request. When the access request is received and it is determined that the access request was received during the rental period (or during a scheduled pickup window, etc.), an access command or instruction may be sent to the selected machine as discussed below with respect to operation 1806.

As an example of the process 1700, a contractor may open the renter application on a user device and submit a rental search request for a scissor lift needed from May 1 through May 10 at a first location. The application may query a database of rental machines (e.g., stored in the cloud 268) and generate a list of all the machines that are identified as scissor lifts and available for rental from May 1 through May 10. The application may generate a user interface containing the list and may display the list on the screen of the user device. The machines may be listed in order of distance from the first location. In some embodiments, the list may only include machines located within a given radius of the first location. In some embodiments, the user interface may include a map indicating locations of the available machines, rather than or in addition to the list. Once the list is delivered to the screen of the user device, the user may further filter or sort the list. For example, the user may filter the list to remove machines with low fuel levels and machines with a maximum operating height under 30 feet. The application may update the user interface to reflect the filtered list. The user may select an option to sort the list, for example, by rental price. After the list has been optionally filtered and/or sorted, the user may select a machine from the list. The application may then prompt the user to fill out a rental agreement and submit payment information to finalize the rental reservation.

In some embodiments, the selected machine may track the use of the selected machine during the rental period. The method 1700 may include receiving a usage statistic from a connectivity module of the selected machine at the end of the rental period. The usage statistic may indicate how much the machine was used during the rental period. The usage statistic may include at least one of at least one of a change in battery charge during the rental period, a change in fuel level during the rental period, or an operating time of the machine during the rental period. In some embodiments, the final rental price may be calculated in part based on the usage statistic. For example, a renter that uses a machine for only one hour during a one-day rental period may be charged less than a user that uses the machine for five hours during a one-day rental period. This may allow the equipment owner to recoup costs for fuel and depreciation more fairly from the renters.

The method 1700 may further include receiving availability data for one or more machines from a device of one or more equipment owners. For example, an owner user interface may be generated and may be sent to the equipment owner device. The owner may enter information relating to rentable equipment via the user interface. For example, the owner may input a list of equipment that the owner wants to make available to rent. The list may then be stored in the one or more memory devices to be accessed by potential renters. Once the machines are stored in the system, the equipment owner may enter the availability data for the machines. The availability data may include the dates that the machines are available for rent, available pickup times, whether delivery is offered, a maximum rental period, etc. This availability data can be used to generate the user interface at operation 1704 identifying machines that

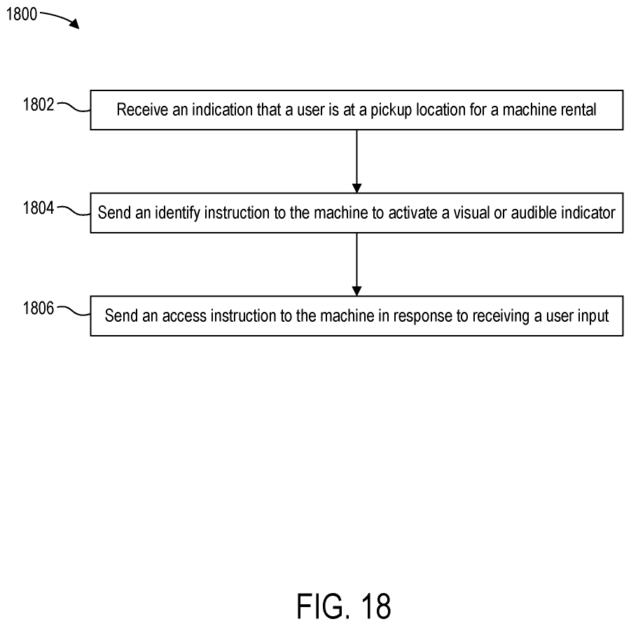

Referring now to FIG. 18, a process 1800 (e.g., a method) for picking up a rented work machine is shown, according to some embodiments. The process 1800 may allow a renter to pick up a machine without requiring the presence or assistance of the machine's owner. The process 1800 may be performed by one or more processing circuits comprising one or more memory devices (e.g., non-transitory computer-readable storage media) coupled to one or more processors, as described above with respect to the process 1700, and may follow the process 1700 after a machine has been selected and a rental agreement finalized. In some embodiments, the process 1700 may include some or all of the operations of process 1800 and vice-versa. At operation 1802, an indication is received that the user is at the pickup location. The indication may be a user input, or the application may detect the location of the user device (e.g., via GPS) and automatically determine that the user is at the pickup location. At operation 1804, an identify instruction is sent to the selected machine to generate a visual indication or audible indication or signal. It should be understood that instructing the machine to generate an indication may include instructing a connectivity module coupled to the machine to generate the indication. Before sending the instruction, the application may confirm that the rental period has begun or that the user is at the pickup location within a specified pickup window. The user may then identify the selected machine based on the visual or audible indication generated by the indicator.

The indicator may be, for example, a beacon integrated into the connectivity module that includes a light, which is lit when the instruction to generate the indication is received. Additionally or alternatively, the connectivity module can instruct the machine's lights (e.g., headlights, cabin lights, etc.) to act as the visible indicator. The beacon may additionally or alternatively include a speaker to provide the audible indication. Additionally or alternatively, the connectivity module can instruct the machine's safety horn to act as the audible indicator. The visual and audible indicators can be used in conjunction or independently of one another. In some embodiments, the instruction to generate the indication may be sent in response to a user input. In other embodiments, the instruction may be sent automatically in response to receiving the indication that the user is at the pickup location. In some embodiments, operation 1804 may not be required, for example, because the machine is easily identifiable without the visual or audible indication. For example, the machine may be the only machine of its type at the pickup location.

At operation 1806, in response to a user input, an access instruction may be sent to the selected machine. In some embodiments, receipt of the access instruction by the selected machine causes a door of a cab of the machine (e.g., a telehandler) to unlock. In some embodiments, receipt of the access instruction by the selected machine causes a lockbox to unlock. The lockbox may contain a key that can be used to unlock and activate the machine. In some embodiments, receipt of the access instruction causes the machine to activate (e.g., to start the engine, or move the machine into accessory mode and enable starting the engine and/or operating the machine). As discussed above with respect to operation 1804, the application may confirm that the rental period has begun (and not ended) or that the user is at the pickup location within a specified pickup window, sending the access instruction only after confirming. Once the machine has been unlocked and activated, the machine can be moved and loaded onto a truck for transportation to the renter's jobsite. In some embodiments, the machine is keyless, and the application can be user to activate and deactivate the machine at the renter's jobsite.

As an example of the process 1800, after a renter has confirmed a reservation of a telehandler, with a pickup window of 8:00 AM-12:00 PM on May 1, the user may arrive at the owner's job site to pick up the machine at 9:00 AM on May 1. The application may detect that the user has arrived based on the GPS location of the user device. After confirming that the user is within the pickup window, the application sends an instruction to the machine to activate a visible beacon. The application may instruct the user that the beacon has been activated on the rented machine. The user may then identify the rented machine, for example, among a group of similar machines. The user may then select an “Unlock” button on the user interface to unlock a door to the cab of the telehandler. Once inside the telehandler, the user can select an “Activate” button on the user interface to activate the telehandler. The user can then drive the telehandler onto a flatbed truck for transportation to the renter's jobsite. Near the end of the rental period, the user may then drop the machine off at the pickup location, or another location as specified in the rental agreement. Similar to picking up the machine, the application may confirm that the machine is being dropped off during a scheduled drop-off window. Additional fees can be charged if the machine is dropped off outside the drop-off window and/or if the rental period has expired. The user may select an “End Reservation” button on the user interface once the machine has been dropped off. The application may confirm that the machine is in the drop-off location, e.g., via the machine's GPS location before closing the reservation and calculating the final rental fees.

In some embodiments, the rental fee may be calculated, at least in part, based on use of the machine. For example, the fuel or battery level at the end of the rental may be compared to the fuel or battery level at the beginning of the rental. The renter may be charged a fee based on the amount of fuel or battery charge used. This may allow the owner to recover the value of the used fuel or electricity. In some embodiments, the amount of time the machine is activated during the rental period may be used to determine the rental fee. Thus, a rental in which a machine is used continuously during the rental period may incur higher charges than a rental in which the machine is used only sporadically throughout the rental period. This may allow the owner to better recover the depreciation of the machine based on use.

In some embodiments, various users may share a pool of machines. In some embodiments, a user may have a subscription or membership allowing the user to access machines owned by an owner. In these embodiments, it may not be necessary to submit a rental search request and complete a rental agreement each time a machine is needed. A user may be permitted to pick up available machines without a reservation or advanced notice. For example, a user may use the user application to identify the locations of available machines and may go to the location of a desired machine without a reservation. In some embodiments the user application may allow the user to send an identify instruction to all available machines located within a predetermined distance of the user device, so that the user can identify the machines available for rent. The user may then select an available machine and submit an access instruction via the user application to access and activate the machine. In some embodiments, the user may select a machine by scanning a QR code, a barcode, or a machine identification number via the user application using the user device. Sending the access instruction may signal the beginning of a rental period, or the user may select a “Begin Rental” button on the user interface to begin the rental period. During the rental period, the usage of the machine may be tracked as described above (e.g., via fuel or battery usage or time-of-use data). When the user is finished with the machine, the user can drop the machine off and select an “End Rental” button on the application. Fees can be charged based on the tracked usage information and/or the length of the rental period.

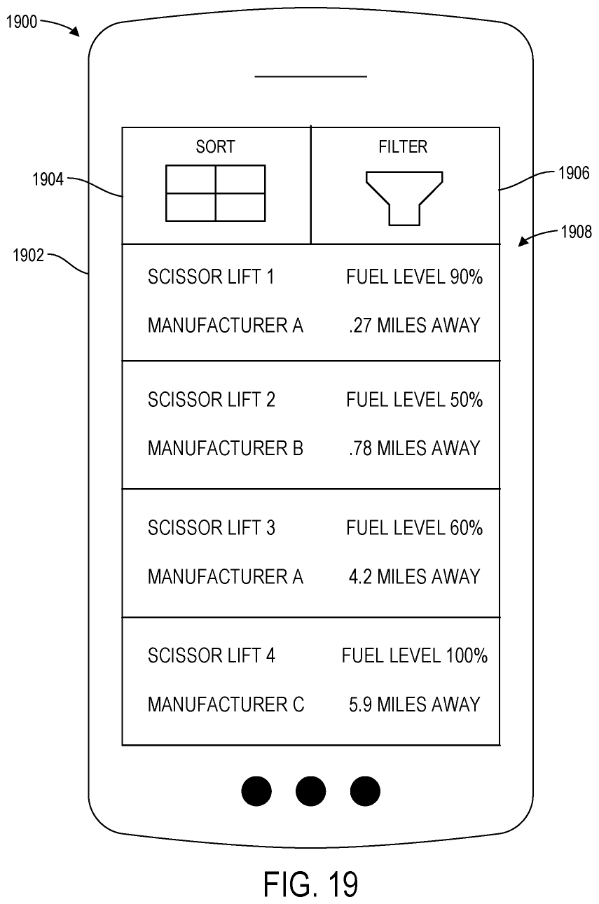

Referring now to FIG. 19, a user interface 1900 is shown on the screen of a user device 1902, according to some embodiments. The user interface 1900 shows a list of machines 1908 that meet rental search criteria and are available for rent. User interface 1900 may be, for example, the user interface generated at operation 1704 of process 1700. Each machine in the list 1908 may include information about the machine, including, for example, the distance from the machine to an input jobsite location, the manufacturer of the machine, the fuel or battery status of the machine, the maximum or minimum operating height of the machine, the load capacity of the machine, the cost to rent the machine etc. The user interface 1900 may include a sort button 1904 that a user may select to sort the list 1908 by, for example, price, distance away, or any other listed attribute of the machine. The user interface 1900 may include a filter button 1906 that a user may select to filter the list 1908 by, for example, manufacturer, fuel level, load capacity, or any other listed attribute of the machine.

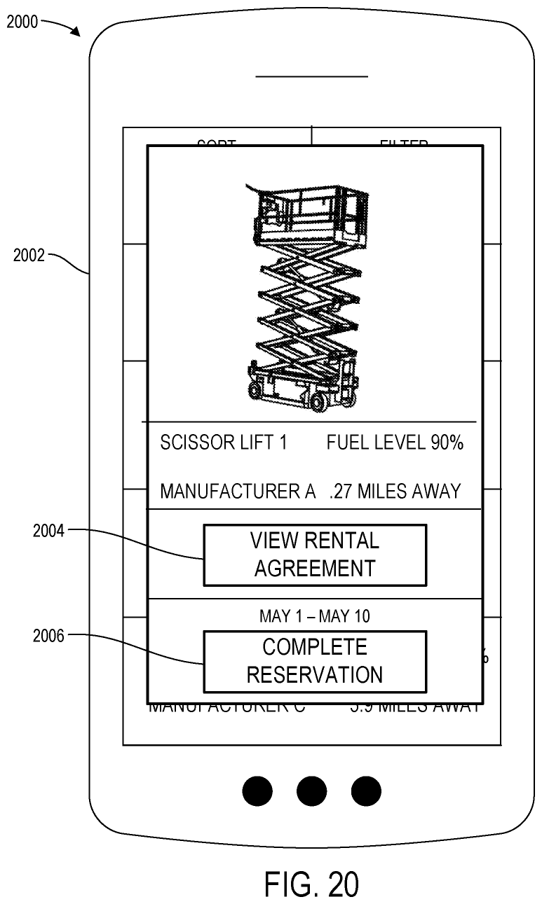

Referring now to FIG. 20, a user interface 2000 is shown on the screen of a user device 2002, according to some embodiments. The user interface 200 may be displayed after a user has selected a machine from the list 1908 on user interface 1900. The user interface 2000 includes a “View Rental Agreement” button that, when selected, causes a rental agreement (e.g., the rental agreement generated at operation 1708 of the process 1700) to be displayed on the user device 2002. The user may then read and digitally sign the agreement. The user interface 2000 includes a “Complete Reservation” button 2006. After the user selects this button, the rental reservation of the sleeted machine may be confirmed. The “Complete Reservation” button 2006 may not be selectable until the rental agreement has been viewed and/or signed.

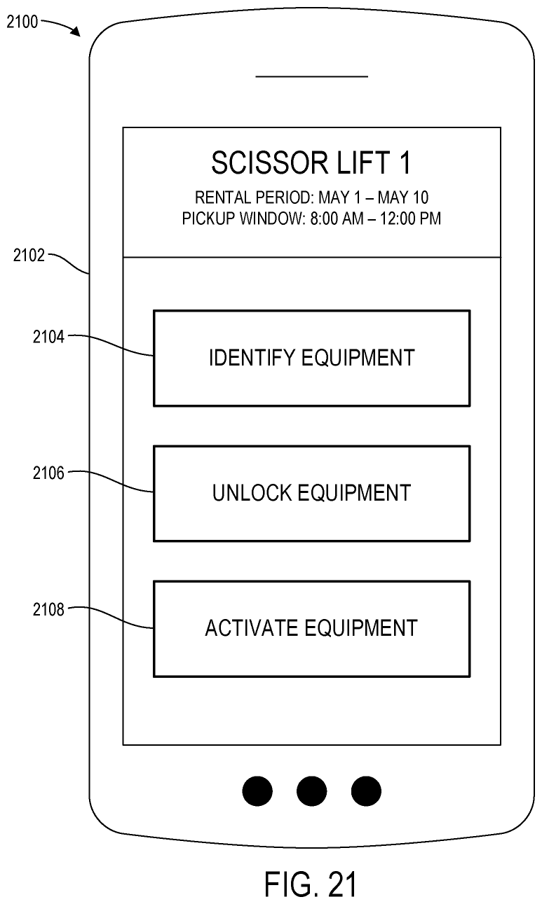

Referring now to FIG. 21, a user interface 2100 is shown on the screen of a user device 2102, according to some embodiments. The user interface 2100 includes an “Identify Equipment” button 2104 that, when selected, sends an identify instruction to a selected machine (e.g., the identify instruction sent at operation 1804 of the method 1800). The identify instruction may cause the selected machine to generate a visual or audible indication so the selected machine can be identified. The user interface 2100 includes an “Unlock Equipment” button 2106 that, when selected, sends an access instruction to a selected machine (e.g., the access instruction sent at operation 1806 of the method 1800). The access instruction sent in response to selecting the “Unlock Equipment” button 2106 may cause a door or lockbox of the machine to unlock. The user interface 2100 includes an “Activate Equipment” button 2108 that, when selected, sends an access instruction to a selected machine (e.g., the access instruction sent at operation 1806 of the method 1800). The access instruction sent in response to selecting the “Activate Equipment” button 2108 may cause the machine to activate.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using one or more separate intervening members, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

While various circuits with particular functionality are shown in FIGS. 1-3, it should be understood that the controller 44 may include any number of circuits for completing the functions described herein. For example, the activities and functionalities of the control system 60 may be combined in multiple circuits or as a single circuit. Additional circuits with additional functionality may also be included. Further, the controller 44 may further control other activity beyond the scope of the present disclosure.

As mentioned above and in one configuration, the “circuits” of the control system 60 may be implemented in machine-readable medium for execution by various types of processors, such as the processor 52 of FIG. 1. An identified circuit of executable code may, for instance, comprise one or more physical or logical blocks of computer instructions, which may, for instance, be organized as an object, procedure, or function. Nevertheless, the executables of an identified circuit need not be physically located together but may comprise disparate instructions stored in different locations which, when joined logically together, comprise the circuit and achieve the stated purpose for the circuit. Indeed, a circuit of computer readable program code may be a single instruction, or many instructions, and may even be distributed over several different code segments, among different programs, and across several memory devices. Similarly, operational data may be identified and illustrated herein within circuits and may be embodied in any suitable form and organized within any suitable type of data structure. The operational data may be collected as a single data set or may be distributed over different locations including over different storage devices, and may exist, at least partially, merely as electronic signals on a system or network.

While the term “processor” is briefly defined above, the term “processor” and “processing circuit” are meant to be broadly interpreted. In this regard and as mentioned above, the “processor” may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example, the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system, etc.) or remotely (e.g., as part of a remote server such as a cloud based server). To that end, a “circuit” as described herein may include components that are distributed across one or more locations.

Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A method of facilitating the rental of a work machine, the method comprising:
receiving, from a user device, a rental search request including search criteria, the search criteria comprising a type of machine, a rental period, and a jobsite location;
generating a user interface identifying one or more machines of the received type of machine that are available to rent during the rental period and are located within a predetermined distance of the jobsite location;
sending the user interface to the user device, receipt of the user interface causing a screen of the user device to display the user interface; and
receiving, from the user device, a selection of a machine from the one or more machines indicating a request to rent the selected machine.

2. The method of claim 1, wherein the user interface comprises a list of the one or more machines organized in order from nearest to farthest from the jobsite location.

3. The method of claim 2, further comprising filtering the list based on an additional attribute, wherein the additional attribute is one of: an equipment manufacturer, a maximum operating parameter, a minimum operating parameter, a rental price, a fuel level, or a battery charge level.

4. The method of claim 2, further comprising sorting the list based on an additional attribute, wherein the additional attribute is one of: an equipment manufacturer, a maximum operating parameter, a minimum operating parameter, a rental price, a fuel level, or a battery charge level.

5. The method of claim 1, wherein the user interface comprises a map that identifies the locations of the one or more machines.

6. The method of claim 1, further comprising receiving, from a connectivity module of the machine at the end of the rental period, a usage statistic comprising at least one of a change in battery charge during the rental period, a change in fuel level during the rental period, or an operating time of the machine during the rental period; and
calculating a final rental price based at least in part on the usage statistic.

7. The method of claim 1, further comprising receiving, from an equipment owner device, availability data for one or more rentable machines.

8. The method of claim 1, further comprising:
generating a rental agreement for the selected machine for the rental period;
generating a second user interface containing the rental agreement; and
sending the second user interface to the screen of the user device.

9. The method of claim 8, further comprising receiving, from the user device, an indication of consent to the rental agreement.

10. A method of retrieving a rented work machine, the method comprising:
receiving, from a user device, an indication that a user is at a pickup location for a rented machine; and
sending, to the machine in response to a user input via the user device, an access instruction, receipt of the access instruction causing one of: unlocking a door of the machine, unlocking a lockbox coupled to the machine, or activating the machine.

11. The method of claim 10, further comprising determining whether the user has permission to pick up the machine by confirming that a pickup window for the machine has begun and has not ended, wherein the access instruction is sent to the machine only if the permission is confirmed.

12. The method of claim 10, further comprising sending, to the machine in response to a second user input via the user device, an identify instruction, receipt of the identify instruction causing the machine to generate one or both of an audible signal or a visible signal.

13. The method of claim 12, wherein the visible signal comprises at least one of activating headlights of the machine, activating interior cabin lights of the machine, or activating a light of a beacon coupled to the machine.

14. The method of claim 12, wherein the audible signal comprises at least one of activating a safety horn of the machine or activating a sound generator or speaker of a beacon coupled to the machine.

15. The method of claim 12, further comprising determining whether the user has permission to pick up the machine by confirming that a pickup window for the machine has begun and has not ended, wherein the identify instruction is sent to the machine only if the permission is confirmed.

16. A non-transitory computer-readable storage medium having instructions stored thereon that, upon execution by a processor, cause the processor to:
receive, from one or more equipment owner devices, availability data for a plurality of rentable machines;
receive, from a user device, a rental search request including search criteria, the search criteria comprising a type of machine, a rental period, and a jobsite location;
generate a list of one or more of the plurality of rentable machines that matches the type of machine and is available for rent during the rental period;
sort the list based on distance from each rentable machine to the jobsite location; and
receive, from the user device, a selection of a rentable machine from the list, the selection indicating a request to rent the selected machine.

17. The non-transitory computer-readable storage medium of claim 16, wherein the instructions, upon execution by a processor, further cause the processor to generate a rental agreement for the selected machine for the rental period.

18. The non-transitory computer-readable storage medium of claim 17, wherein the instructions, upon execution by a processor, further cause the processor to:
receive, from the user device, an indication of consent to the rental agreement; and
in response to receiving the indication of consent, enable access to the selected machine during the rental period.

19. The non-transitory computer-readable storage medium of claim 18, wherein enabling access to the selected machine during the rental period comprises:
receiving, from the user device, an access request;
determining that the access request was received during the rental period; and
sending, in response to determining the access request was sent during the rental period, an access command to the selected machine, receipt of the access command causing one of: unlocking a door of the machine, unlocking a lockbox coupled to the machine, or activating the machine.

20. The non-transitory computer-readable storage medium of claim 16, wherein the instructions, upon execution by a processor, further cause the processor to:
receive, from a connectivity module of the machine at the end of the rental period, a usage statistic comprising at least one of a change in battery charge during the rental period, a change in fuel level during the rental period, or an operating time of the machine during the rental period; and
calculate a final rental price based at least in part on the usage statistic.
